(19) United States
(12) Patent Application Publication
(10) Pub. No.: US 2008/0181696 A1
(43) Pub. Date: Jul. 31, 2008

(54) IMAGE FORMING APPARATUS AND IMAGE FORMING METHOD USING THE SAME

(75) Inventors: Jin Soo LEE, Suwon-si (KR); Byung Sun Ahn, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/950,728

(22) Filed: Dec. 5, 2007

(30) Foreign Application Priority Data
Jan. 25, 2007 (KR) 2007-7856

(51) Int. Cl. G03G 15/00

(52) U.S. Cl. 399/364

(57) ABSTRACT

An image forming apparatus and an image forming method using the same. The image forming apparatus includes a discharge unit which has a driving roller rotating in forward and reverse directions and first and second driven rollers engaged with the driving roller to rotate together therewith, a duplex print unit which feeds the paper again to a developing unit so that the paper printed on a first surface is subsequently printed on a second surface, and a control unit which controls a rotational direction of the driving roller so as to move a first sheet of paper between the driving roller and the first driven roller and move a second sheet of paper between the driving roller and the second driven roller. Accordingly, the image forming apparatus is capable of controlling the forward movement of the second sheet of paper without interference with the reverse movement of the first sheet of paper, thereby decreasing a time required to perform duplex printing.

### CROSS-REFERENCE TO RELATED APPLICATIONS

This application claims the benefit of Korean Patent Application No. 2007-0007856, filed on Jan. 25, 2007 in the Korean Intellectual Property Office, the disclosure of which is incorporated herein in its entirety by reference.

### BACKGROUND OF THE INVENTION

1. Field of the Invention

The present general inventive concept relates to an image forming apparatus, and more particularly, to an image forming apparatus which is capable of printing images on both surfaces of a printing medium.

2. Description of the Related Art

A conventional image forming apparatus is an apparatus that prints images on a printing medium, i.e., paper, according to an input image signal. A typical image forming apparatus is configured to print images on one surface (a first surface) of the paper. Recently, an image forming apparatus has been developed. The image forming apparatus is configured to print images on the first surface of the paper and reversely feed the paper to print images on an opposite surface (a second surface) of the paper.

As illustrated in FIG. 1, the conventional image forming apparatus includes a paper feeding unit 10 for supplying paper P, a developing unit 30 for developing images on the paper P, a fixing unit 50 for fixing the images on the paper P by applying heat and pressure to the paper P, and a discharge unit 60 for discharging the printed paper P which has passed through the fixing unit 50 to an exterior of the image forming apparatus.

The conventional image forming apparatus is provided with a duplex print path 71 so that the paper upon which a first image is printed on a first surface thereof is fed again to the developing unit 30 and the fixing unit 50 to have an image printed on a second surface thereof. The paper P printed on the first surface is fed to the duplex print path 71 by reversely rotating a discharge roller 61 and a discharge reversal roller 62 of the discharge unit 60, and passes through the developing unit 30 and the fixing unit 50 to be printed on the second surface.

An operation of the above conventional image forming apparatus will now be described. A first sheet of paper P has an image printed first on the first surface thereof. The first sheet of paper printed on the first surface passes through the duplex print path 71, and then is printed on the second surface. In the duplex printing process of the first sheet of paper, a second sheet of paper is kept on standby in the paper feeding unit 10. After the first sheet of paper is printed on the second surface, the second sheet of paper begins to be printed on the first surface. The second sheet of paper printed on the first surface passes through the duplex print path 71, and then is printed on the second surface.

However, the above conventional image forming apparatus has the problem of a long print time, because the second sheet of paper is kept on standby in the paper feeding unit before the duplex printing process of the first sheet of paper is completed.

### SUMMARY OF THE INVENTION

The present general inventive concept provides an image forming apparatus which is capable of decreasing time required to perform duplex printing.

The present general inventive concept also provides an image forming method using the above image forming apparatus.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept are achieved by providing a image forming apparatus including a paper feeding unit which supplies paper, a developing unit which develops images on the paper supplied from the paper feeding unit, a fixing unit which fuses the images on the paper, a discharge unit which has a driving roller rotating in forward and reverse directions, a first driven roller disposed at one side of the driving roller and engaged with the driving roller to rotate together with the driving roller, and a second driven roller disposed at another side of the driving roller and engaged with the driving roller to rotate together with the driving roller; a duplex print unit which feeds the paper again to the developing unit so that the paper printed on a first surface through the developing unit and the fixing unit is subsequently printed on a second surface, and a control unit which controls a rotational direction of the driving roller so as to move a first sheet of paper between the driving roller and the first driven roller and move a second sheet of paper between the driving roller and the second driven roller.

The control unit may be configured to control the driving roller to rotate in the forward direction so as to move the first sheet of paper between the driving roller and the first driven roller, and then control the driving roller to rotate in the reverse direction so as to reversely move the first sheet of paper toward the duplex print unit and simultaneously move the second sheet of paper without interference with the reverse movement of the first sheet of paper.

The control unit may be configured to further control the driving roller to rotate in the forward direction to reversely move the second sheet of paper passing between the driving roller and the second driven roller toward the duplex print unit.

Between the fixing unit and the discharge unit formed may be a first discharge path through which the first sheet of paper moves between the driving roller and the first driven roller, a first reversal path through which the first sheet of paper passing through the first discharge path reversely moves toward the duplex print unit, a second discharge path through which the second sheet of paper moves between the driving roller and the second driven roller without interference with the reverse movement of the first sheet of paper through the first reversal path, and a second reversal path through which the second sheet of paper passing through the second discharge path reversely moves toward the duplex print unit.

The image forming apparatus may further include a sensor which is provided adjacent to the first discharge path, the first reversal path, the second discharge path, and the second reversal path to sense the movement of the first sheet of paper and the second sheet of paper, the sensor being electrically connected to the control unit so that the control unit controls the rotational direction of the driving roller.

The image forming apparatus may further include a guide member which is provided adjacent to the first discharge path, the first reversal path, the second discharge path, and the second reversal path, the guide member being controlled by the control unit to guide the first sheet of paper and the second sheet of paper to move selectively to the first discharge path, the first reversal path, the second discharge path, and the second reversal path.

The foregoing and/or other aspects and utilities of the present general inventive concept may also be achieved by providing an image forming method of the image forming apparatus including the discharge unit, the duplex print unit, and the control unit, including rotating the driving roller in a forward direction to move the first sheet of paper printed on the first surface between the driving roller and the first driven roller, and if a portion of the first sheet of paper passes between the driving roller and the first driven roller by a predetermined length, rotating the driving roller in a reverse direction to reversely move the first sheet of paper toward the duplex print unit and simultaneously move the second sheet of paper printed on the first surface between the driving roller and the second driven roller without interference with the reverse movement of the first sheet of paper.

The image forming method may further include if a portion of the second sheet of paper passes between the driving roller and the second driven roller by a predetermined length, rotating the driving roller in the forward direction to reversely move the second sheet of paper toward the duplex print unit and simultaneously discharge the first sheet of paper printed on the second surface through a gap between the driving roller and the first driven roller, and rotating the driving roller in the reverse direction to discharge the second sheet of paper printed on the second surface through a gap between the driving roller and the second driven roller.

The foregoing and/or other aspects and utilities of the present general inventive concept may also be achieved by providing a image forming apparatus, including a developing unit to develop a first image on a first surface of a first sheet of paper and a discharge unit having a plurality of rollers to feed the first sheet of paper to a duplex print path while a second sheet of paper is fed to the developing unit to print a second image on a first surface of the second sheet of paper, and to re-feed the first sheet of paper to the developing unit to print a third image on a second surface of the first sheet of paper.

The feeding of the first sheet of paper and the second sheet of paper may be based on forward and reverse rotational movements of the plurality of rollers.

The plurality of rollers may include a driving roller to rotate in forward and reverse directions, a first driven roller engaged with the driving roller to rotate together with the driving roller, and a second driven roller engaged with the driving roller to rotate together with the driving roller.

The image forming apparatus may further include a control unit to control the driven roller to rotate in the reverse direction to guide the first sheet of paper to the duplex printing path while the second sheet of paper is fed to the developing unit and moves between the driving roller and the second driven roller.

The driving roller may rotate in the forward direction to feed the first sheet of paper to the developing unit to develop the third image on the second surface of the first sheet of paper when a predetermined amount of the second sheet of paper passes between the driving roller and the second driven roller.

The image forming apparatus may further include a sensor to sense when the predetermined amount of the second sheet of paper has passed between the driving roller and the second driven roller.

The second sheet of paper may be fed to the developing unit to print a fourth image on a second surface of the second sheet of paper when the plurality of rollers discharges the first sheet of paper outside the image forming apparatus.

The plurality of rollers may include a first set of rollers to feed the first sheet of paper, and a second set of rollers to feed the second sheet of paper.

The first set of rollers may include a common driving roller and a first driven roller, and the second set of rollers comprises the common driving roller and a second driven roller.

The common driving roller may be disposed between the first driven roller and the second driven roller.

The foregoing and/or other aspects and utilities of the present general inventive concept may also be achieved by providing a image forming apparatus, including a developing unit disposed on a printing path to print on a sheet of paper, and a discharge unit to discharge the sheet of paper and to feed the sheet of paper back to the printing path through the discharge unit having a first set of rollers to feed a first sheet of paper and a second set of rollers to feed a second sheet of paper.

### BRIEF DESCRIPTION OF THE DRAWINGS

These and/or other aspects and utilities of the exemplary embodiments of the present general inventive concept will become apparent and more readily appreciated from the following description of the embodiments, taken in conjunction with the accompanying drawings, of which:

FIG. 1 is a sectional view illustrating a conventional image forming apparatus;

FIG. 2 is a sectional view illustrating an image forming apparatus in accordance with an embodiment of the present general inventive concept;

FIG. 3 is an enlarged view of an “A” portion in FIG. 2;

FIG. 4 is a block diagram illustrating a control relationship of an image forming apparatus in accordance with an embodiment of the present general inventive concept;

FIGS. 5A, 5B, 5C, and 5D are views illustrating an image forming method using an image forming apparatus in accordance with an embodiment of the present general inventive concept; and

FIG. 6 is a flowchart illustrating an image forming method according to an embodiment of the present general inventive concept.

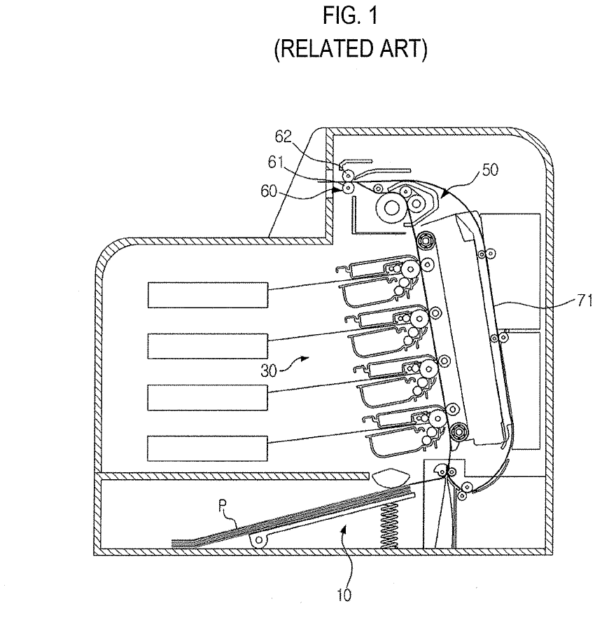

### DETAILED DESCRIPTION OF THE PREFERRED EMBODIMENTS

Reference will now be made in detail to exemplary embodiments of the present general inventive concept, examples of which are illustrated in the accompanying drawings, wherein like reference numerals refer to like elements throughout. The embodiments are described below to explain the present general inventive concept by referring to the figures.

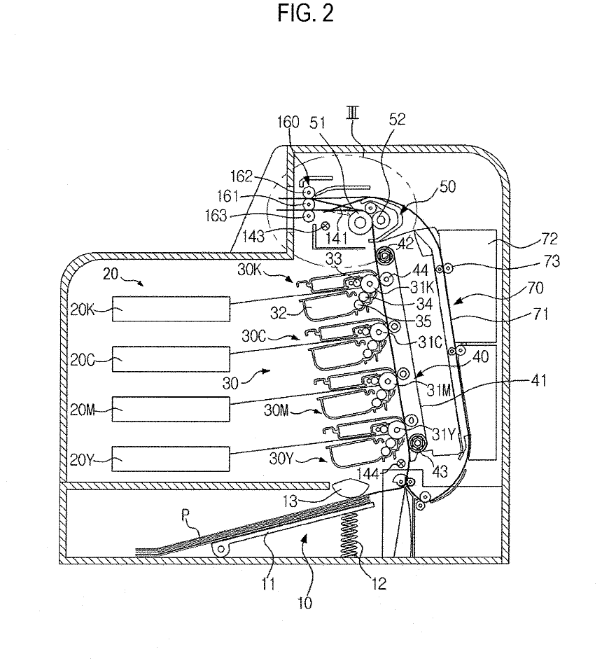

As illustrated in FIG. 2, an image forming apparatus according to an embodiment of the present general inventive concept includes a paper feeding unit 10, an exposure unit 20, a developing unit 30, a transfer unit 40, a fixing unit 50, a discharge unit 160, and a duplex print unit 70.

The paper feeding unit 10 to supply paper P includes a paper tray 11 on which the paper P is loaded, and a spring 12 which elastically supports the paper tray 11. The paper P loaded on the paper tray 11 is picked up by a pickup roller 13 sheet by sheet, and is moved toward the developing unit 30.

The developing unit 30 includes four toner cartridges 30Y, 30M, 30C and 30K, in which toners of different colors, e.g., yellow (Y), magenta (M), cyan (C) and black (K), are respectively contained. The respective toner cartridges 30Y, 30M, 30C and 30K are provided with photosensitive bodies 31Y, 31M, 31C and 31K on which an electrostatic latent image is formed by the exposure unit 20. The respective exposure units 20Y, 20M, 20C and 20K irradiate light corresponding to image information of yellow (Y), magenta (M), cyan (C) and black (K) to the photosensitive bodies 31Y, 31M, 31C and 31K of the respective toner cartridges according to a print signal.

Each of the toner cartridges 30Y, 30M, 30C and 30K includes a toner container 32 to store the toner, a charge roller 33 to charge each of the photosensitive bodies 31Y, 31M, 31C and 31K, a developing roller 34 to develop the electrostatic latent image formed on each of the photosensitive bodies 31Y, 31M, 31C and 31K to a toner image, and a supply roller 35 to supply the toner to the developing roller 34.

The transfer unit 40 is included to transfer the toner image developed on the photosensitive bodies 31Y, 31M, 31C, and 31K to the paper P. The transfer unit 40 includes a transfer belt 41 which circulates while contacting the photosensitive bodies 31Y, 31M, 31C and 31K, a driving roller 42 which drives the transfer belt 41, a tension roller 43 which maintains a constant tensile force corresponding to the transfer belt 41, and four transfer rollers 44 which transfer the toner image developed on the photosensitive bodies 31Y, 31M, 31C and 31K onto the paper P.

The fixing unit 50 to fix the visible image on the paper P by applying heat and pressure to the paper P includes a heat roller 51 which has a heat source to heat the toner-transferred paper P, and a press roller 52, which is disposed opposite to the heat roller 51, and maintains the constant fixing pressure with the heat roller 51.

The discharge unit 160 to discharge the printed paper P to the exterior of the image forming apparatus includes a driving roller 161, a first driven roller 162 which is disposed above the driving roller 161 and engaged with the driving roller 161 to rotate together therewith, and a second driven roller 163 which is disposed below the driving roller 161 and engaged with the driving roller 161 to rotate together therewith.

The duplex print unit 70 is to reversely move the paper P having an image printed on a first surface thereof so as to be subsequently printed on a second surface thereof. The duplex print unit 70 includes a guide frame 72 which forms a duplex print path 71, and a duplex print roller 73 which is mounted on the duplex print path 71 to feed the paper P.

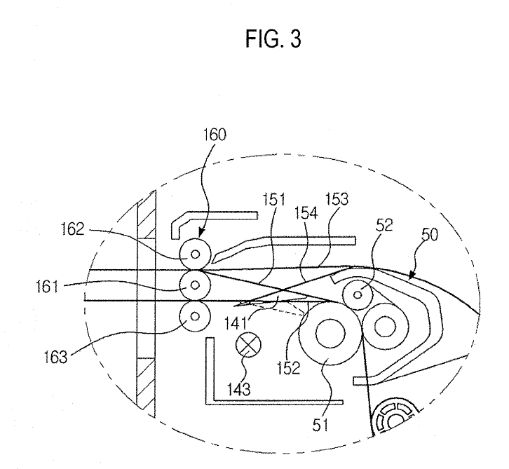

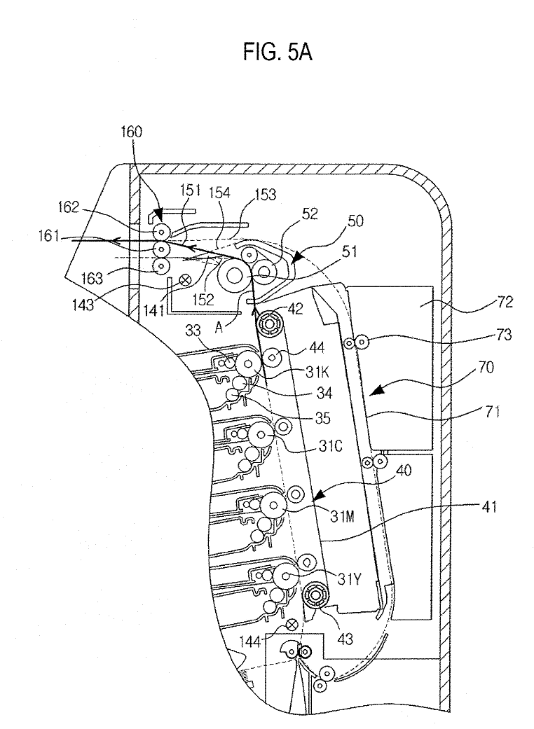

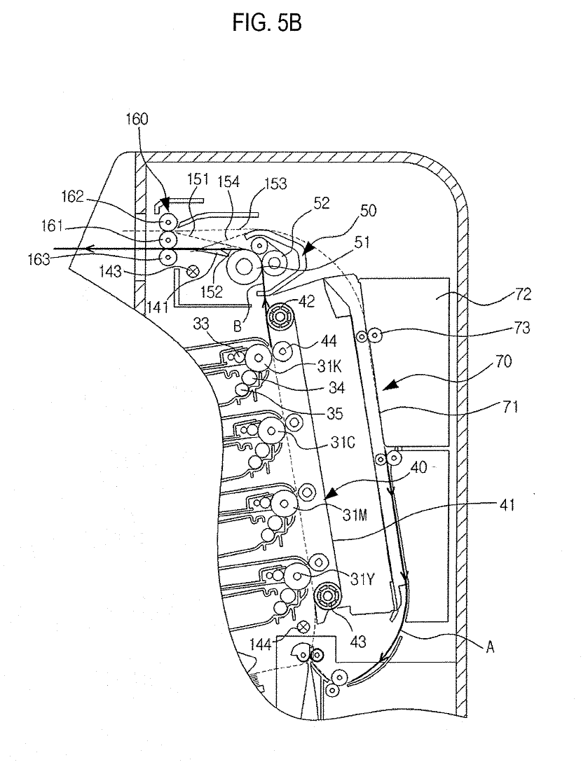

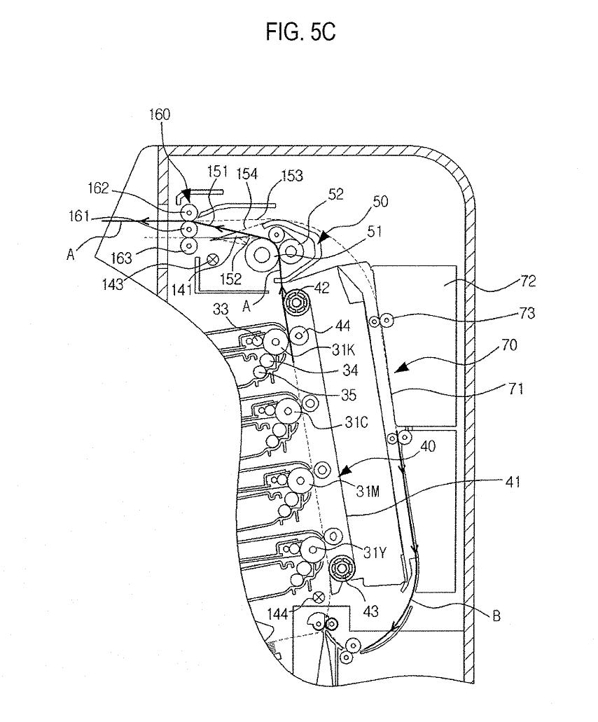

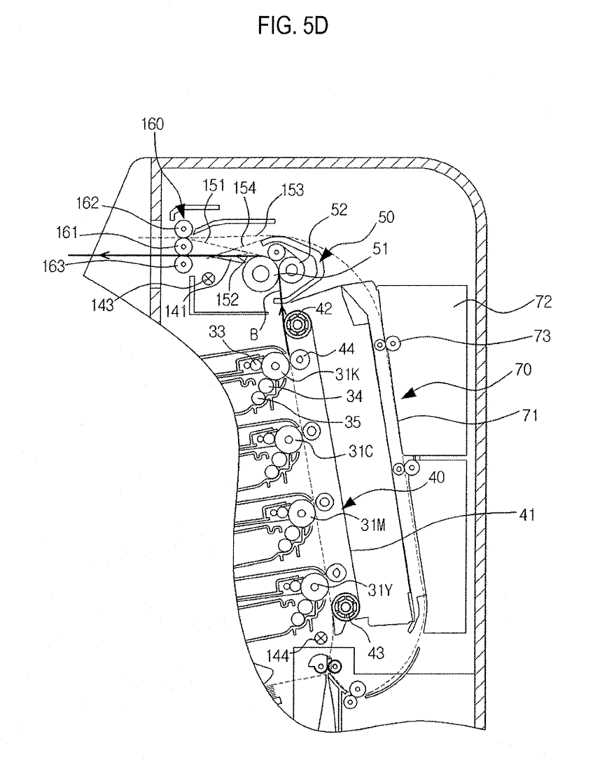

Referring to FIGS. 5A through 5D, the image forming apparatus of the present general inventive concept performs the duplex print operation corresponding to two consecutively fed sheets of paper P during each operational cycle. Referring to FIGS. 3 and 5A through 5D, a first sheet of paper A moves between the driving roller 161 and the first driven roller 162, and a second sheet of paper B moves between the driving roller 161 and the second driven roller 163. The second sheet of paper B may be a sheet of paper which immediately follows the first sheet of paper A during the duplex print operation.

Accordingly, a first discharge path 151 through which the first sheet of paper A having passed through the fixing unit 50 moves between the driving roller 161 and the first driven roller 162 is formed between the discharge unit 160 and the fixing unit 50. A first reversal path 153 through which the first sheet of paper A passing through the first discharge path 151 moves toward the duplex print path 71 of the duplex print unit 70 is also formed between the discharge unit 160 and the fixing unit 50 Also, a second discharge path 152 through which the second sheet of paper B having passed through the fixing unit 50 moves between the driving roller 161 and the second driven roller 163, and a second reversal path 154 through which the second sheet of paper B passing through the second discharge path 152 moves toward the duplex print path 71 of the duplex print unit 70 are also formed between the discharge unit 160 and the fixing unit 50.

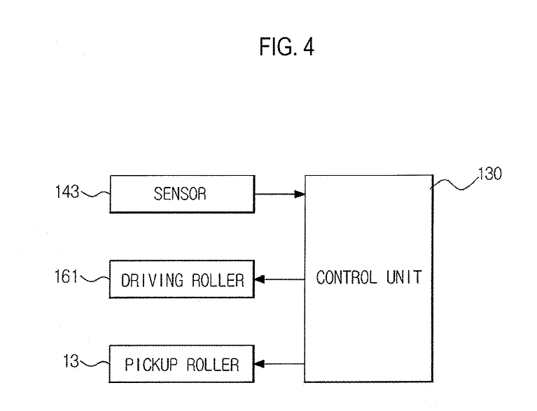

A guide member 141 is provided below or to correspond to the above-described paths 151, 152, 153 and 154, in order to guide the first sheet of paper A and the second sheet of paper B to move selectively to the paths 151, 152, 153 and 154. For example, if the guide member 141 is controlled to ascend by a control unit 130 of FIG. 4, the guide member 141 guides the first sheet of paper A having the image printed on the first surface thereof to move between the driving roller 161 and the first driven roller 162. A sensor 143 is further provided below the above-described paths 151, 152, 153 and 154, in order to sense the first sheet of paper A and the second sheet of paper B passing through the paths 151, 152, 153 and 154. A sensor 144 in FIG. 2 may sense the first sheet of paper A and the second sheet of paper B supplied from the paper feeding unit 10 and/or the duplex printing unit 70.

As illustrated in FIG. 4, the forward movement and the reverse movement of the first sheet of paper A and the second sheet of paper B in the duplex print process are controlled by the control unit 130.

In response to a sensing signal from the sensor 143, the control unit 130 controls the driving roller 161 to rotate in the forward direction so that the first sheet of paper A moves forwardly, and controls the driving roller 161 to rotate in the reverse direction so that the first sheet of paper A moves reversely toward the duplex print unit 70. Also, the control unit 130 changes the position of the guide member 141.

Further, while controlling the driving roller 161 to reversely move the first sheet of paper A toward the duplex print unit 70, the control unit 130 also controls the pickup roller 13 of the paper feeding unit 10 so that the second sheet of paper B has an image printed on a first surface thereof.

Also, the control unit 130 controls the driving roller 161 to rotate in the forward direction so that the second sheet of paper B with an image printed on the first surface thereof moves reversely toward the duplex print unit 70, and controls the driving roller 161 to rotate in the reverse direction so that the second sheet of paper B has an image printed on a second surface thereof and moves forwardly.

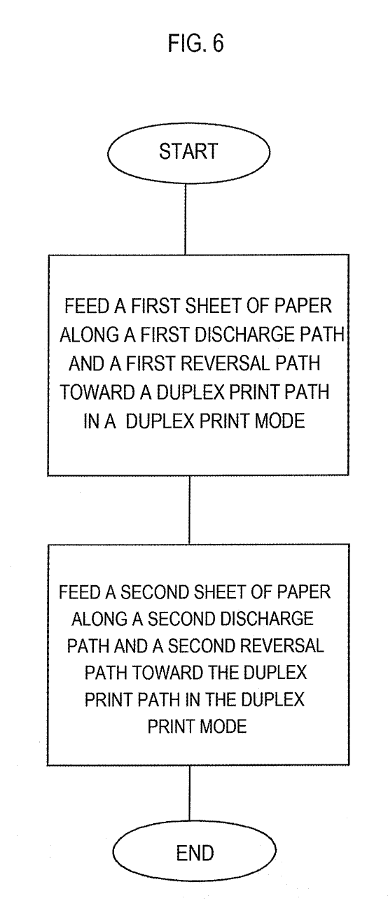

Hereinafter, an image forming method of the image forming apparatus according to an embodiment of the present general inventive concept will be described with reference to FIGS. 5A through 5D and FIG. 6. For convenience in explanation, the description of the process of supplying the first sheet of paper A and printing images on the first surface of the first sheet of paper A will be omitted, and the subsequent print process will now be described in detail.

The first sheet of paper A with an image printed on the first surface thereof passing through the fixing unit 50 is guided to a first discharge path 151, and moves between the driving roller 161 and the first driven roller 162. Referring to FIG. 5A, the sensor 143 senses the first sheet of paper A moving through the first discharge path 151.

Thereafter, when a portion of the first sheet of paper A passes between the driving roller 161 and the first driven roller 162 by a predetermined length or more, the sensor 143 outputs the corresponding signal to the control unit 130. In response to the signal from the sensor 143, the control unit 130 controls the driving roller 161 to rotate in the reverse direction.

If the driving roller 161 rotates in the reverse direction, the first sheet of paper A moves reversely to the duplex print path 71 of the duplex print unit 70 through the first reversal path 153. At the same time, the control unit 130 controls the paper feeding unit 10 so that the second sheet of paper B is printed on the first surface and moves between the driving roller 161 and the second driven roller 163. Referring to FIG. 5B, the reverse movement of the first sheet of paper A and the forward movement of the second sheet of paper B do not overlap or interfere with each other.

When a portion of the second sheet of paper B having an image printed on the first surface thereof passes between the driving roller 161 and the second driven roller 163 by a predetermined length or more, the sensor 143 outputs the corresponding signal to the control unit 130. In response to the signal from the sensor 143, the control unit 130 controls the driving roller 161 to rotate in the forward direction.

Referring to FIG. 5C, if the driving roller 161 rotates in the forward direction, the second sheet of paper B moves reversely to the duplex print path 71 of the duplex print unit 70, and the first sheet of paper A has an image printed on the second surface thereof and then is discharged to the exterior of the image forming apparatus through a gap between the driving roller 161 and the first driven roller 162.

Referring to FIG. 5D, the driving roller 161 is controlled to rotate in the reverse direction so that the second sheet of paper B with the image printed on the first surface thereof subsequently has an image printed on the second surface thereof. And then, the second sheet of paper B is discharged to the exterior of the image forming apparatus through a gap between the driving roller 161 and the second driven roller 163. Thereby, the image forming process is completed.

Referring to FIG. 6, the image forming method of the image forming apparatus according to an embodiment of the present general inventive concept will be described. In operation 610, the first sheet of paper A is fed along the first discharge path 151 and the first reversal path 153 toward the duplex print path 71 during a duplex printing mode. Subsequently, in operation 620, the second sheet of paper B is fed along the second discharge path 152 and the second reversal path 154 toward the duplex print path 71 during the duplex printing mode.

The present general inventive concept can also be embodied as computer-readable codes on a computer-readable medium. The computer-readable medium can include a computer-readable recording medium and a computer-readable transmission medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, and optical data storage devices. The computer-readable recording medium can also be distributed over network coupled computer systems so that the computer-readable code is stored and executed in a distributed fashion. The computer-readable transmission medium can transmit carrier waves or signals (e.g., wired or wireless data transmission through the Internet). Also, functional programs, codes, and code segments to accomplish the present general inventive concept can be easily construed by programmers skilled in the art to which the present general inventive concept pertains.

As apparent from the above description, an image forming apparatus according to an embodiment of the present general inventive concept is equipped with a discharge unit which is capable of controlling a forward movement of a second sheet of paper without interference with a reverse movement of a first sheet of paper, thereby decreasing a time required to perform duplex printing.

Although embodiments of the present general inventive concept have been shown and described, it would be appreciated by those skilled in the art that changes may be made in this embodiment without departing from the principles and spirit of the general inventive concept, the scope of which is defined in the claims and their equivalents.

What is claimed is:

1. An image forming apparatus, comprising:
a paper feeding unit to supply paper;
a developing unit to develop images on the paper supplied from the paper feeding unit;
a fixing unit to fuse the images on the paper;
a discharge unit, comprising:
a driving roller to rotate in forward and reverse directions,
a first driven roller disposed at one side of the driving roller and engaged with the driving roller to rotate together with the driving roller, and
a second driven roller disposed at another side of the driving roller and engaged with the driving roller to rotate together with the driving roller;
a duplex print unit to feed the paper again to the developing unit so that the paper printed on a first surface through the developing unit and the fixing unit is subsequently printed on a second surface; and
a control unit to control a rotational direction of the driving roller to move a first sheet of paper between the driving roller and the first driven roller and move a second sheet of paper between the driving roller and the second driven roller.

2. The image forming apparatus according to claim 1, wherein the control unit is configured to control the driving roller to rotate in the forward direction to move the first sheet of paper between the driving roller and the first driven roller, and then control the driving roller to rotate in the reverse direction to reversely move the first sheet of paper toward the duplex print unit and simultaneously move the second sheet of paper without interference with the reverse movement of the first sheet of paper.

3. The image forming apparatus according to claim 2, wherein the control unit is configured to further control the driving roller to rotate in the forward direction to reversely move the second sheet of paper passing between the driving roller and the second driven roller toward the duplex print unit.

4. The image forming apparatus according to claim 3, wherein between the fixing unit and the discharge unit formed are a first discharge path through which the first sheet of paper moves between the driving roller and the first driven roller, a first reversal path through which the first sheet of paper passing through the first discharge path reversely moves toward the duplex print unit, a second discharge path through which the second sheet of paper moves between the driving roller and the second driven roller without interference with the reverse movement of the first sheet of paper through the first reversal path, and a second reversal path through which the second sheet of paper passing through the second discharge path reversely moves toward the duplex print unit.

5. The image forming apparatus according to claim 4, further comprising:
a sensor provided adjacent to the first discharge path, the first reversal path, the second discharge path, and the second reversal path to sense the movement of the first sheet of paper and the second sheet of paper, the sensor being electrically connected to the control unit so that the control unit controls the rotational direction of the driving roller.

6. The image forming apparatus according to claim 5, further comprising:
a guide member provided adjacent to the first discharge path, the first reversal path, the second discharge path, and the second reversal path, the guide member being controlled by the control unit to guide the first sheet of paper and the second sheet of paper to move selectively to the first discharge path, the first reversal path, the second discharge path, and the second reversal path.

7. An image forming method of an image forming apparatus including a paper feeding unit to supply paper, a developing unit to develop images on the paper, a fixing unit to fuse the images on the paper, a discharge unit including a driving roller, a first driven roller disposed at one side of the driving roller, and a second driven roller disposed at another side of the driving roller, a duplex print unit to feed the paper again to the developing unit so that the paper printed on a first surface through the developing unit and the fixing unit is subsequently printed on a second surface, and a control unit to control a rotational direction of the driving roller to move a first sheet of paper between the driving roller and the first driven roller and move a second sheet of paper between the driving roller and the second driven roller, the method comprising:
rotating the driving roller in a forward direction to move the first sheet of paper printed on the first surface between the driving roller and the first driven roller; and
if a portion of the first sheet of paper passes between the driving roller and the first driven roller by a predetermined length, rotating the driving roller in a reverse direction to reversely move the first sheet of paper toward the duplex print unit and simultaneously move the second sheet of paper printed on the first surface between the driving roller and the second driven roller without interference with the reverse movement of the first sheet of paper.

8. The method according to claim 7, further comprising:
if a portion of the second sheet of paper passes between the driving roller and the second driven roller by a predetermined length, rotating the driving roller in the forward direction to reversely move the second sheet of paper toward the duplex print unit and simultaneously discharge the first sheet of paper printed on the second surface through a gap between the driving roller and the first driven roller; and
rotating the driving roller in the reverse direction to discharge the second sheet of paper printed on the second surface through a gap between the driving roller and the second driven roller.

9. An image forming apparatus, comprising:
a developing unit to develop a first image on a first surface of a first sheet of paper; and
a discharge unit having a plurality of rollers to feed the first sheet of paper to a duplex print path while a second sheet of paper is fed to the developing unit to develop a second image on a first surface of the second sheet of paper, and to re-feed the first sheet of paper to the developing unit to print a third image on a second surface of the first sheet of paper.

10. The image forming apparatus of claim 9, wherein the feeding of the first sheet of paper and the second sheet of paper is based on forward and reverse rotational movements of the plurality of rollers.

11. The image forming apparatus of claim 9, wherein the plurality of rollers comprises:
a driving roller to rotate in forward and reverse directions;
a first driven roller engaged with the driving roller to rotate together with the driving roller; and
a second driven roller engaged with the driving roller to rotate together with the driving roller.

12. The image forming apparatus of claim 11, further comprising:
a control unit to control the driven roller to rotate in the reverse direction to guide the first sheet of paper to the duplex printing path while the second sheet of paper is fed to the developing unit and moves between the driving roller and the second driven roller.

13. The image forming apparatus of claim 11, wherein the driving roller rotates in the forward direction to feed the first sheet of paper to the developing unit to print the third image on the second surface of the first sheet of paper when a predetermined amount of the second sheet of paper passes between the driving roller and the second driven roller.

14. The image forming apparatus of claim 13, further comprising:
a sensor to sense when the predetermined amount of the second sheet of paper has passed between the driving roller and the second driven roller.

15. The image forming apparatus of claim 9, wherein the second sheet of paper is fed to the developing unit to develop a fourth image on a second surface of the second sheet of paper when the plurality of rollers discharges the first sheet of paper outside the duplex image forming apparatus.

16. The image forming apparatus of claim 9, wherein the plurality of rollers comprises:
a first set of rollers to feed the first sheet of paper; and
a second set of rollers to feed the second sheet of paper.

17. The image forming apparatus of claim 16, wherein:
the first set of rollers comprises a common driving roller and a first driven roller; and
the second set of rollers comprises the common driving roller and a second driven roller.

18. The image forming apparatus of claim 17, wherein the common driving roller is disposed between the first driven roller and the second driven roller.

19. An image forming apparatus, comprising:
a developing unit disposed on a printing path to print on a sheet of paper; and
a discharge unit to discharge the sheet of paper and to feed the sheet of paper back to the printing path through the discharge unit having a first set of rollers to feed a first sheet of paper and a second set of rollers to feed a second sheet of paper.
